(19) United States
(12) Patent Application Publication
(10) Pub. No.: US 2016/0330991 A1
(43) Pub. Date: Nov. 17, 2016

(54) TEA LEAVES AND PROCESS FOR PRODUCING SAME

(71) Applicant: ITO EN, LTD., Tokyo (JP)

(72) Inventors: Eisei NISHITANI, Makinohara-shi (JP); Masami SASAME, Makinohara-shi (JP); Keisuke NUMATA, Makinohara-shi (JP); Satoshi OISHI, Makinohara-shi (JP)

(73) Assignee: ITO EN, LTD., Tokyo (JP)

(21) Appl. No.: 15/110,872

(22) PCT Filed: Feb. 17, 2014
(86) PCT No.: PCT/JP2014/053599

§ 371 Date: Jul. 11, 2016

(51) Int. Cl. A23F 3/10; B65D 85/808

(52) U.S. Cl. CPC A23F 3/10; B65D 85/808

(57) ABSTRACT

The present invention provides new tea leaves from which it is possible to extract tea which well suits Japanese-style foods, is rich in tastiness, and has a light flowery aroma. These tea leaves are characterized by containing (A) a lipid, (B) a tannin, (C) a hydrophilic low-molecular-weight tea polyphenol, and (D) a semi-hydrophilic low-molecular-weight tea polyphenol in a mass proportion that satisfies the following relationships (1) and (2).

0.20≦(A)/(B)≦0.50 (1)

0.15≦(D)/[(C)+(D)]≦0.35 (2)

### TECHNICAL FIELD

The present invention relates to tea leaves from which light tea with an excellent flavor that goes well with a refreshing meal, such as Japanese-style food, can be extracted, and the manufacturing methods thereof.

### BACKGROUND ART

Black tea goes well with sweet tastes, particularly Western-style confectionary, because of its moderate aroma and bitter astringent taste. It is a beverage with tastiness and enjoyable differences in aroma among the areas of production.

Tea leaves from which black tea is extracted are produced by the fermentation of leaves and stems of a tea plant belonging to the Theaceae family; Camellia sinensis var. Catechin receives enzymatic action through this fermentation and components with a moderate flavor, such as theaflavin, are produced by oxidation and polymerization. Differences in flavor can be made by adjusting the degree of fermentation.

As an invention related to tea utilizing fermentation, fermented tea produced by mixing and crumpling tea leaves with materials, such as pear fruit, is disclosed in Patent literature 1 below, and it is described that tea extracted from these leaves has an action suppressing rises in blood glucose levels.

In Patent literature 2 below, a semi-fermented food and drink manufacturing method characterized by semi-fermentation by cutting tea leaves using a cutter mixer, spraying water, heating to a specified temperature, and stirring is disclosed and it is described that semi-fermented tea with a high polymerized polyphenol content rate can be produced using this manufacturing method.

The taste of tea is roughly constituted with the astringency of tannin, bitter taste of caffeine, and umami of amino acids, and the taste can be adjusted by controlling the contents thereof. For example, it is described in Patent literature 3 below that caffeine is reduced by blowing tea leaves with warm water. In Patent literature 4, a method to increase glutamic acid and polyphenol by heating tea leaves with superheated steam followed by crushing is described.

### PRIOR ART DOCUMENTS

### Patent Literature

Patent literature 1: Japanese Unexamined Patent Application Publication No. 2007-202481

Patent literature 2: Japanese Unexamined Patent Application Publication No. 2009-247232

Patent literature 3: Japanese Unexamined Patent Application Publication No. 2011-167091

Patent literature 4: Japanese Unexamined Patent Application Publication No. 2011-217641

### SUMMARY OF THE INVENTION

### Problems to be Solved by the Invention

Healing and relaxation are sought in modern society. In this trend of the times, fermented tea, such as black tea, is a beverage with tastiness and a moderate aroma with enjoyable differences in aroma among the areas of production, and it is suitable to obtain feelings of healing and relaxation. Many tea bags containing black tea leaves are in circulation and it is easy to drink at home, which is another attractive point.

On the other hand, mild tasting meals that give a feeling of healing are preferred, including Japanese-style foods.

Although black tea and Japanese-style foods are healing and relaxing individually, ingestion of these together does not go well because the strong aroma of black tea counteracts moderate meals with a delicate taste, such as Japanese-style food, losing the taste unique to Japanese-style foods.

The taste of tea is roughly constituted with astringency, bitter taste, and umami, as described above, and some people feel an excess in the bitter astringent taste unpleasant.

In fermented tea, including black tea, polyphenol is oxidized and polymerized, producing polymerized polyphenol, which is likely to have a heavy bitter and astringent taste leaving a strong after-taste.

The objective of the present invention is to provide tea leaves with a new flavor from which tea rich in tastiness with a light flowery aroma and a reduced bitter and astringent taste that goes well with Japanese-style foods can be extracted, and the manufacturing methods thereof.

### Means for Solving the Problem

Fermented tea leaves of the present invention are characterized by containing (A) lipids, (B) tannin, (C) hydrophilic low-molecular-weight tea polyphenols, and (D) semi-hydrophilic low-molecular-weight tea polyphenols at the mass ratios shown in (1) and (2) below:

(A)/(B)=0.20-0.50 (1)

(D)/[(C)+(0)]=0.15-0.35 (2)

Manufacturing methods of fermented tea leaves of the present invention are characterized by washing raw tea leaves with 60-100° C. water followed by fermentation.

Tea leaves of the present invention are new tea leaves from which tea rich in tastiness with a light flowery aroma that goes well with Japanese-style foods can be extracted. Tea extracted from these tea leaves goes well with the sweet taste of Japanese confectionery, such as manju (Japanese steamed bun stuffed with red bean paste), and Western-style confectionery, such as cakes, and also Japanese-style foods such as rice balls. It is also tasty when drunk without food.

### MODE FOR CARRYING OUT THE INVENTION

An embodiment of tea leaves of the present invention (expressed as ‘the tea leaves’ below) is explained below, but the present invention is not limited to thereto.

(Each Component of the Tea Leaves)

The tea leaves are characterized by containing (A) lipids, (B) tannin, (C) hydrophilic low-molecular-weight tea polyphenols, and (D) semi-hydrophilic low-molecular-weight tea polyphenols at the mass ratios shown in (1) and (2) below:

(A)/(B)=0.20-0.50 (1)

(D)/[(C)+(D)]=0.15-0.35 (2)

It is preferable that the tea leaves contain (A) lipids at 2-8 mass %, preferably 2-6 mass % and 2.5-5.5 mass %.

(A) Lipids in the tea leaves represent lipid components containing palmitic acid, oleic acid, linoleic acid, and linolenic acid as a constituent fatty acid.

(A) Lipids contribute to the after-taste of tea, and when the content is high, an insistent taste of hard leaves is felt, whereas when the content is low, the taste is too refreshing. Therefore, the content is preferable to be within the range described above.

It is preferable that the tea leaves contain (B) tannin at 5-18 mass %, particularly 8-15 mass % and 9-14 mass %.

(B) Tannin in the tea leaves includes (C) hydrophilic low-molecular-weight tea polyphenols and (D) semi-hydrophilic low-molecular-weight tea polyphenols, for example, catechins, theaflavins, gallic acid, theogallin, and thearubigin.

Catechins in the tea leaves represent catechin (C), gallocatechin (GC), catechin gallate (Cg), gallocatechin gallate (GCg), epicatechin (EC), epigallocatechin (EGC), epicatechin gallate (ECg), and epigallocatechin gallate (EGCg), and theaflavins represent theaflavin, theaflavin monogallate, such as theaflavin-3-gallate and theaflavin-3′-gallate, and theaflavin digallate such as theaflavin-3,3′-digallate.

(B) Tannin contributes to astringency, and the taste becomes astringent when it is excessively present, and bland when the content is low. Thus, its content is preferable to be within the range described above.

It is preferable that the tea leaves contain (A) lipids at a mass ratio against (B) tannin, [(A)/(B)], of 0.20-0.50, preferably 0.25-0.45, and more preferably, 0.30-0.40.

When (A)/(B) is lower than 0.2, the taste becomes bland, emphasizing astringency, and when it exceeds 0.5, the taste becomes stronger, with a feeling of the taste of hard leaves. Thus, it is preferable to be within the range described above.

It is preferable that the tea leaves contain (C) hydrophilic low-molecular-weight tea polyphenol at 2-15 mass %, particularly 3-12 mass % and 3-10 mass %.

(C) Hydrophilic low-molecular-weight tea polyphenols in the tea leaves represent low-molecular-weight tea polyphenols classified based on the value of the molecular weight/number of hydroxyl groups, and components with a value of the molecular weight/number of hydroxyl groups lower than 58. Specifically, for example, gallic acid, theogallin, gallocatechin (GC), gallocatechin gallate (GCg), epigallocatechin (EGC), and epigallocatechin gallate (EGCg) are included. For the composition, it is preferable that EGCg accounts for 40-65%, particularly 50-60%, of (C) hydrophilic low-molecular-weight tea polyphenols (c).

It is preferable that the content of (C) hydrophilic low-molecular-weight tea polyphenols is within the range described above because it contributes to rising patterns of aroma, and the aroma becomes too strong when its content is low, whereas the aroma does not irritate the nose when its content is too high.

It is preferable that the tea leaves contain (D) semi-hydrophilic low-molecular-weight tea polyphenols at 0.5-5 mass %, particularly 0.5-3 mass % and 1-2.5 mass %.

(D) Semi-hydrophilic low-molecular-weight tea polyphenol in the tea leaves represent low-molecular-weight tea polyphenols classified based on the value of the molecular weight/number of hydroxyl groups, and components with a value of the molecular weight/number of hydroxyl groups of 58 or higher. Specifically, for example, catechin (C), catechin gallate (Cg), epicatechin (EC), epicatechin gallate (ECg), theaflavin, theaflavin monogallate, and theaflavin digallate are included. For the composition, it is preferable that ECg accounts for 30-55% of (D) semi-hydrophilic low-molecular-weight tea polyphenols (d).

It is preferable that the content of (D) semi-hydrophilic low-molecular-weight tea polyphenols is within the range described above because it contributes to patterns of after-taste, and the after-taste becomes bland when the content is low, and it becomes persistent when the content is too high.

For the tea leaves, it is preferable that the mass ratio of (D) semi-hydrophilic low-molecular-weight tea polyphenols to the total of (C) hydrophilic low-molecular-weight tea polyphenols and (D) semi-hydrophilic low-molecular-weight tea polyphenols ‘(D)/[(C)+(D)]’ is 0.15-0.35, particularly 0.20-0.35 and 0.25-0.30.

It is preferable that (D)/[(C)+(D)] is within the range described above because when it is lower than 0.15, the aroma is weak and the taste is felt to be bland, and when it exceeds 0.35, the flowery aroma is too strong and impairs the good match with Japanese-style foods.

It is preferable that the tea leaves contain (E) caffeine at 0.5-2.5 mass %, particularly 0.7-2.5 mass % and 0.7-2 mass %.

It is preferable that the content of (E) caffeine is within the range described above because it constitutes the bitter taste of tea, and when its content exceeds 2.5 mass %, it tastes slightly offensive, but when the content is less than 0.5 mass %, the taste is felt not enough.

It is preferable that the tea leaves contain theanine at 0.2-5 mass %, particularly 0.3-3 mass % and 0.3-1.5 mass %.

Theanine represents glutamic acid derivatives contained in tea leaves, for example, L- or D-glutamic acid-γ-alkylamide, such as L-glutamic acid-γ-ethylamide (L-theanine), L-glutamic acid-γ-methylamide, D-glutamic acid-γ-ethylamide (D-theanine), and D-glutamic acid-γ-methylamide, or derivatives containing L- or D-glutamic acid-γ-alkylamide in the basic structure (for example, glycoside of L- or D-glutamic acid-γ-alkylamide).

It is preferable that the theanine content is within the range described above because it contributes to the taste of umami, and when the content is too high the sense of concentration rises and the taste becomes persistent, but when the content is low the bitter astringent taste stands out.

The tea leaves may contain sugars, such as monosaccharides and disaccharides, minerals, such as potassium, and organic acids, such as malic acid, in addition to the components described above.

The tea leaves are fermented tea leaves with excellent flavor, from which tea with a light flowery aroma can be extracted and the bitter astringent taste is reduced. Tea extracted from the tea leaves goes well with sweet tastes, such as Japanese confectionery including Manju (Japanese steamed bun stuffed with red bean paste), and Western-style confectionery including cakes, as well as Japanese-style foods such as rice balls. This tea is also tasty when it is drunk without food and it is also refreshing when tea is drunk little by little over a prolonged period (sipping (chibidaranomi)) or drunk in one gulp to lessen thirst.

The tea leaves can be used as leaf-type tea leaves as well as broken and CTC types. The tea leaves can also be used for tea bags and materials for beverages. Particularly, the tea leaves are appropriate for tea bags, and it is preferable to be cut into small pieces and used.

Tea leaves as the materials of beverages are those to industrially mass-produce tea beverages packaged in containers, and for containers filled with tea beverages, for example, plastic bottles (i.e., pet bottles), metal cans, such as steel and aluminum cans, glass bottles, and paper containers can be used, particularly, transparent containers, such as pet bottles, can be preferentially used.

(Manufacturing Method of the Tea Leaves)

For the tea leaves, it is important to adjust the mass ratio of (A) lipids, (B) tannin, (C) hydrophilic low-molecular-weight tea polyphenols, and (D) semi-hydrophilic low-molecular-weight tea polyphenols within the ranges of (A)/(B) of 0.20-0.50 and (D)/[(C)+(D)] of 0.15-0.35, and these can be obtained by appropriately adjusting, for example, the selection of 1 or more types of materials of tea leaves, the combination and blending ratio thereof, various conditions of aqueous cleaning, the processing method of raw tea leaves, and the fermentation process, as described below.

For the material, tea leaves, leaves, stems, and buds of Theaceae tea plants (Camellia sinensis var.) can be used, and the cultivar, region of cultivation, cultivation conditions, picking period, and picking method of the material of tea leaves are not particularly limited.

For example, cultivars of tea include Yabukita, Yutaka Midori, Sayamakaori, Kanayamidori, Okumidori, Asatsuyu, Sae Midori, Benifuuki, Benifuji, Benihomare, Yaeho, Benihikari, Yamakai, Fujikaori, Koushun, and Chinese, Assam, and Taiwan tea species, and tree types include tall and low tree types.

The region of cultivation of the material of tea leaves is not particularly limited as long as cultivation thereof is possible, and it may be in Japan or outside Japan. Specifically, the region of cultivation in Japan includes, for example, Shizuoka, Kagoshima, Mie, and Kyoto prefectures. Tea leaves collected from tea plants grown outside Japan may be used. The picking period (seasonal period) is also not particularly limited.

The cultivation conditions and picking method of the material of tea leaves are not particularly limited, and for example, known methods or modified methods based on these may be appropriately used.

The material of tea leaves may be withered.

Aqueous cleaning can be performed by, for example, contacting the material of tea leaves to warm or hot water, specifically 60-100° C., preferably 80-100° C., for 10-180 seconds.

Since caffeine in the material of tea leaves is eluted by aqueous cleaning, caffeine can be decreased.

Aqueous cleaning is not particularly limited, but it is preferable to mix at a mass ratio of the material of tea leaves:water=1:5-1:50, particularly 1:10-1:40 to contact the material of tea leaves to water for 10-180 seconds, particularly 30-120 seconds.

This contact is not particularly limited, but the material of tea leaves may be contacted to water by immersion in water and stirring, being sprayed with warm water like a shower, or being placed in flowing water.

It is preferable to process raw tea leaves after aqueous cleaning (expressed as ‘cleaned tea leaves’ below) by kneading, such as coarse kneading and crumpling, before fermentation, similarly to the conventional black tea manufacturing method. Specifically, it is preferable to apply coarse kneading, crumpling, tea ball breaking, and sifting and then compression and cutting using a rotor vane and CTC.

Fermentation can be performed by adding an enzyme source containing polyphenol oxidizing enzyme. Cleaned tea leaves cannot be subjected to the fermentation process without modification because aqueous cleaning described above inactivates enzymes. Thus, an enzyme source containing polyphenol oxidizing enzyme is added to induce fermentation. For the enzyme source, for example, other raw tea leaves and withered leaves prepared by withering other raw tea leaves can be used. For these raw tea leaves, tea leaves described above as examples of the material of tea leaves can be used. Drugs containing polyphenol oxidizing enzyme can also be used, but the use of tea leaf-derived enzymes is preferable.

When raw tea leaves are used as an enzyme source, it is preferable to mix leaves at a mass ratio of cleaned tea leaves:raw tea leaves=5:95-95:5, particularly 10:90-90:10.

Fermentation is not particularly limited, but it can be performed, for example, while maintaining the room temperature at 20-50° C., preferably 25-40° C., and humidity at 50-100%, preferably 80-100%, and it is preferable to adjust the moisture of the tea leaves to 30-80 mass % of the material of tea leaves, particularly 50-75 mass %, and tea leaves may be rocked to increase contact with air at a rate not drying the leaves.

Tea leaves may be completely or semi-fermented, not being particularly limited, but it is preferable to perform it for 10 minutes-6 hours, particularly 30 minutes-3 hours.

To stop fermentation of tea leaves, it is preferable to stop by drying, similarly to that in the conventional black tea manufacturing method. Drying can be performed by, for example, blowing 50-100° C. wind. It is preferable to dry so as to adjust moisture of tea leaves to 1-8 mass % of the material of tea leaves, particularly 3-6 mass %.

The tea leaves can be produced using tea leaves prepared by this manufacturing method alone or mixing several preparations.

The tea leaves are fermented tea leaves with excellent flavor as described above from which tea with a light flowery aroma can be extracted and the bitter astringent taste is reduced.

(Preparation Method of Each Component)

(A) Lipids, for example, tend to be decreased by aqueous cleaning of the material of tea leaves. Accordingly, the content of (A) lipids can be adjusted in consideration thereof, and when the tea leaves are produced using the manufacturing methods described above, the content of (A) lipids can be adjusted by extending the contact time of the material tea of leaves with water in aqueous cleaning, or adjusting the cleaned tea leaf/enzyme source mixing ratio.

(B) Tannin in the material of tea leaves is, for example, contained at a high level in Assam species, and leaves picked in summer tend to contain much tannin. Accordingly, the content of (B) tannin can be adjusted in consideration thereof, and when the tea leaves are produced using the manufacturing methods described above, the content of (B) tannin can be adjusted by appropriately selecting the material of tea leaves.

(C) Hydrophilic low-molecular-weight tea polyphenols, for example, tend to be decreased by fermentation of the material of tea leaves. Accordingly, the content of (C) hydrophilic low-molecular-weight tea polyphenols can be adjusted in consideration thereof, and when the tea leaves are produced using the manufacturing methods described above, the content of (C) hydrophilic low-molecular-weight tea polyphenols can be adjusted by adjusting the fermentation time and the cleaned tea leaf/enzyme source mixing ratio.

(D) Semi-hydrophilic low-molecular-weight tea polyphenols, for example, increase in the early phase of fermentation of the material of tea leaves and then decrease thereafter. Accordingly, the content of (D) semi-hydrophilic low-molecular-weight tea polyphenols can be adjusted in consideration thereof, and when the tea leaves are produced using the manufacturing methods described above, the content of (D) semi-hydrophilic low-molecular-weight tea polyphenols can be adjusted by adjusting the fermentation time.

(E) Caffeine can be decreased, for example, by aqueous cleaning of the material of tea leaves. Accordingly, the content of (E) caffeine can be adjusted in consideration thereof, and when the tea leaves are produced using the manufacturing methods described above, the content of (E) caffeine can be adjusted by adjusting the water temperature and cleaned tea leaf/enzyme source mixing ratio.

Theanine is, for example, influenced by cover cultivation and picking period, and the content is high in new buds and when the fiber content is low because of an early picking period, whereas the content tends to decrease when the picking period is late and the fiber content is high. Accordingly, the content of theanine can be adjusted in consideration thereof, and when the tea leaves are produced using the manufacturing method described above, the content of theanine can be adjusted by adjusting the picking period of the material of tea leaves and extension of buds and covering.

(Quantitation Method of Each Component)

(A) Lipids, (B) tannin, (C) hydrophilic low-molecular-weight tea polyphenols, (D) semi-hydrophilic low-molecular-weight tea polyphenol, and (E) caffeine in the tea leaves can be quantitated by the methods shown in the examples below.

### Terminology

In the present invention, when figures are presented as ‘X-Y’ (X and Y are specific figures), it indicates ‘X or higher and Y or lower’ including ‘preferably higher than X’ and ‘preferably lower than Y’ unless otherwise specified.

### EXAMPLES

Examples of the present invention are explained below, but the present invention is not limited thereto.

<<Organoleptic Test>>

Tea leaves were prepared as shown in Examples 1-8 and Comparative Examples 1-4, and organoleptic evaluation was performed by drinking tea extracted from these.

### Example 1

For the material of tea leaves, 2 kg of raw leaves of Yabukita grown and picked in early July in Shizuoka Prefecture were used. These leaves were immersed in a cylindrical container containing 40 L of 95° C. hot water and stirred for 60 seconds. The leaves were recovered, rinsed with normal temperature water, placed in a coarse kneading machine (tea manufacturing machine 2K, Kawasaki Kiko Co., Ltd.) and stirred with 60° C. warm air supply to remove water adhering to the tea leaf surface, and 1.8 kg of cleaned tea leaves were prepared.

These cleaned tea leaves, 630 g, were mixed with 30 g of raw tea leaves of Yabukita produced and picked in early July in Shizuoka Prefecture as an enzyme source, crumpled for 30 minutes in a crumpling machine (crumpling machine 2K, Kawasaki Kiko Co., Ltd.), and kept standing for one hour in an environmental testing apparatus (ETAC JUNIOR SD01, Kusumoto Chemicals Ltd.) controlled at 25° C. and 90% RH for fermentation. These fermented tea leaves were then dried by 100° C. hot air supply, and 270 g of tea leaves of Example 1 were prepared.

### Example 2

Cleaned tea leaves, 810 g, prepared as described in Example 1 were mixed with 100 g of raw tea leaves of Yabukita grown and picked in early July in Shizuoka prefecture as an enzyme source, crumpled for 30 minutes in a crumpling machine (crumpling machine 2K, Kawasaki Kiko Co., Ltd.), and kept standing for one hour in an environmental testing apparatus (ETAC JUNIOR SD01, Kusumoto Chemicals Ltd.) controlled at 25° C. and 60% RH for fermentation. These fermented tea leaves were then dried by 100° C. hot air supply, and 275 g of tea leaves of Example 2 were prepared.

### Example 3

For the material of tea leaves, 2 kg of raw tea leaves of Benihomare grown and picked in early July in Shizuoka Prefecture were used. These leaves were immersed in a cylindrical container containing 40 L of 95° C. hot water and kept standing for 60 seconds. The leaves were recovered, rinsed with normal temperature water, placed in a coarse kneading machine (tea manufacturing machine 2K, Kawasaki Kiko Co., Ltd.), and stirred with 60° C. warm air supply to remove water adhering to the tea leaf surface, and 1.86 kg of cleaned tea leaves were prepared.

These cleaned tea leaves, 370 g, were mixed with 600 g of raw tea leaves of Benihomare grown and picked in early July in Shizuoka Prefecture as an enzyme source, crumpled in a crumpling machine (crumpling machine 2K, Kawasaki Kiko Co., Ltd.) for 30 minutes, and kept standing for one hour in an environmental testing apparatus (ETAC JUNIOR SD01, Kusumoto Chemicals Ltd.) controlled at 37° C. and 90% RH for fermentation. These fermented tea leaves were dried by 100° C. hot air supply, and 285 g of tea leaves of Example 1 were prepared.

### Example 4

For the material of tea leaves, 2 kg of raw tea leaves of Yabukita grown and picked in middle of July in in Shizuoka Prefecture were used. These leaves were immersed in a cylindrical container containing 40 L of 80° C. hot water and stirred for 30 seconds. The leaves were recovered, rinsed with normal temperature water, placed in a coarse kneading machine (tea manufacturing machine 2K, Kawasaki Kiko Co., Ltd.), and stirred with 60° C. warm air supply to remove water adhering to the tea leaf surface, and 1.84 kg of cleaned tea leaves were prepared.

These cleaned tea leaves, 740 g, were mixed with 200 g of raw tea leaves of Yabukita grown and picked in early July in Shizuoka Prefecture as an enzyme source, crumpled in a crumpling machine (crumpling machine 2K, Kawasaki Kiko Co., Ltd.) for 10 minutes, and kept standing for 2 hours in an environmental testing apparatus (ETAC JUNIOR SD01, Kusumoto Chemicals Ltd.) controlled at 25° C. and 60% RH for fermentation. The fermented tea leaves were dried with 100° C. hot air supply, and 272 g of tea leaves of Example 1 were prepared.

### Example 5

For the material of tea leaves, 2 kg of raw tea leaves of Yutaka Midori grown and picked in early April in Kagoshima Prefecture were used. These leaves were immersed in a cylindrical container containing 60 L of 80° C. hot water and stirred for 90 seconds. The leaves were recovered, rinsed with normal temperature water, placed in a coarse kneading machine (tea manufacturing machine 2K, Kawasaki Kiko Co., Ltd.), and stirred with 60° C. warm air supply to remove water adhering to the tea leaf surface, and 1.74 kg of cleaned tea leaves were prepared.

These cleaned tea leaves, 435 g, were mixed with 500 g of raw tea leaves of Yutaka Midori grown and picked in early April in Kagoshima Prefecture as an enzyme source, crumpled in a crumpling machine (crumpling machine 2K, Kawasaki Kiko Co., Ltd.) for 30 minutes, and kept standing for 2 hours in an environmental testing apparatus (ETAC JUNIOR SD01, Kusumoto Chemicals Ltd.) controlled at 37° C. and 90% RH for fermentation. The fermented tea leaves were dried with 100° C. hot air supply, and 285 g of tea leaves of Example 1 were prepared.

### Example 6

Cleaned tea leaves, 650 g, prepared as described in Example 3 were mixed with 300 g of raw tea leaves of Benihomare grown and picked in early July in Shizuoka Prefecture, crumpled for 30 minutes in a crumpling machine (crumpling machine 2K, Kawasaki Kiko Co., Ltd.), and kept standing for 2 hours in an environmental testing apparatus (ETAC JUNIOR SD01, Kusumoto Chemicals Ltd.) controlled at 37° C. and 90% RH for fermentation. The fermented tea leaves were dried by 100° C. hot air supply, and 288 g of tea leaves of Example 1 were prepared.

### Example 7

For the material of tea leaves, 2 kg of raw tea leaves of Yabukita grown and picked in early July in Shizuoka Prefecture were used. These leaves were immersed in a cylindrical container containing 40 L of 95° C. hot water and stirred for 60 seconds. The leaves were recovered, rinsed with normal temperature water, placed in a coarse kneading machine (tea manufacturing machine 2K, Kawasaki Kiko Co., Ltd.), and stirred with 60° C. warm air supply to remove water adhering to the tea leaf surface, and 1.85 kg of cleaned tea leaves were prepared.

These cleaned tea leaves, 435 g, were mixed with 30 g of a drug containing a polyphenol-oxidizing enzyme (Laccase Daiwa Y120, Amano Enzyme Inc.) dissolved in 100 mL of water as an enzyme source, crumpled for 30 minutes in a crumpling machine (crumpling machine 2K: Kawasaki Kiko Co., Ltd.), and kept standing for 2 hours in an environmental testing apparatus (ETAC JUNIOR SD01, Kusumoto Chemicals Ltd.) controlled at 37° C. and 90% RH for fermentation. The fermented tea leaves were dried by 100° C. hot air supply, and 538 g of tea leaves of Example 1 were prepared.

### Example 8

Raw tea leaves, 750 g, of Yabukita grown and picked in late September in Shizuoka Prefecture and 250 g of raw tea leaves of Yutaka Midori grown and picked in early April in Kagoshima Prefecture were crumpled for 10 minutes in a crumpling machine (crumpling machine 2K, Kawasaki Kiko Co., Ltd.) and kept standing for 30 minutes in an environmental testing apparatus (ETAC JUNIOR SD01, Kusumoto Chemicals Ltd.) controlled at 25° C. and 90% RH for fermentation. The fermented tea leaves were dried by 100° C. hot air supply, and 272 g of tea leaves of Example 8 were prepared.

### Comparative Example 1

Using 2 kg of raw tea leaves of Yabukita grown and picked in late September in Shizuoka Prefecture, crude tea processing of the conventional green tea manufacturing method was performed, and 455 g of coarse tea was prepared as tea leaves of Comparative Example 1.

### Comparative Example 2

Using 2 kg of raw tea leaves of Yabukita grown and picked in late September in Shizuoka Prefecture, these leaves were immersed in a cylindrical container containing 40 L of 95° C. hot water and stirred for 60 seconds. The tea leaves were recovered, rinsed with normal temperature water, and subjected to crude tea processing of the conventional green tea manufacturing method, and 443 g of coarse tea was prepared as tea leaves of Comparative Example 2.

### Comparative Example 3

Commercial Assam CTC black tea was used as the tea leaves of Comparative Example 3.

### Comparative Example 4

Using 2 kg of raw tea leaves of Yutaka Midori grown and picked in late March in Kagoshima Prefecture, these leaves were crumpled for 30 minutes in a crumpling machine (crumpling machine 2K, Kawasaki Kiko Co., Ltd.) and kept standing for one hour in an environmental testing apparatus (ETAC JUNIORSD01, Kusumoto Chemicals Ltd.) controlled at 25° C. and 90% RH for fermentation. The fermented tea leaves were dried by 100° C. hot air supply, and 385 g of black tea was prepared as the tea leaves of Comparative Example 4.

(Quantitation)

The components of the tea leaves prepared as the Examples and Comparative Examples were quantitated. The results are shown in Table 1 below. Mass % shown in the table represents the mass ratio to the entire mass of tea leaves.

TABLE 1

| | | Example | | | | | | | |
|---|---|---|---|---|---|---|---|---|---|
| | | Example 1 | Example 2 | Example 3 | Example 4 | Example 5 | Example 6 | Example 7 | Example 8 |
| (A) Lipids [mass %] | | 3.5% | 3.1% | 5.2% | 5.1% | 2.8% | 3.2% | 2.9% | 5.5% |
| (B) Tannin [mass %] | | 10.7% | 13.1% | 10.8% | 12.1% | 12.7% | 10.8% | 12.3% | 12.5% |
| (C) Hydrophilic | | 5.8% | 8.0% | 4.3% | 8.6% | 4.4% | 3.7% | 3.8% | 7.8% |
| low-molecular-weight tea | | | | | | | | | |
| polyphenols [mass %] | | | | | | | | | |
| (c) Epigallocatechin gallate | | 3.4% | 3.9% | 1.9% | 4.1% | 2.1% | 1.9% | 2.3% | 3.8% |
| (EGCg) [mass %] | | | | | | | | | |
| (c)/(C) [%] | | 59% | 49% | 44% | 48% | 48% | 51% | 61% | 49% |
| (D) Semi-hydrophilic | | 2.0% | 1.7% | 2.1% | 1.6% | 2.1% | 1.8% | 1.2% | 1.8% |
| low-molecular-weight tea | | | | | | | | | |
| polyphenols [mass %] | | | | | | | | | |
| (d) Epicatechin gallate (Ecg) | | 0.6% | 0.9% | 0.8% | 1.0% | 0.7% | 0.6% | 0.5% | 0.7% |
| [mass %] | | | | | | | | | |
| (d)/(D) [%] | | 30% | 53% | 38% | 63% | 33% | 33% | 42% | 39% |
| (E) Caffeine [mass %] | | 0.8% | 0.7% | 1.8% | 0.9% | 1.4% | 0.8% | 0.8% | 2.7% |
| (A)/(B) | | 0.33 | 0.24 | 0.48 | 0.42 | 0.22 | 0.30 | 0.24 | 0.44 |
| (D)/[(C) + (D)] | | 0.26 | 0.17 | 0.32 | 0.16 | 0.32 | 0.33 | 0.24 | 0.19 |
| Drinking | Matching with rice | 4 | 4 | 3 | 5 | 3 | 3 | 4 | 4 |
| tea with | ball (salted rice ball | | | | | | | | |
| food | with no filling) | | | | | | | | |
| | Matching with cake | 4 | 3 | 5 | 4 | 3 | 5 | 3 | 3 |
| | (chocolate cake) | | | | | | | | |
| Drinking | Sipping over a | 5 | 3 | 4 | 3 | 4 | 5 | 3 | 3 |
| tea | prolonged time | | | | | | | | |
| without | One gulp to lessen | 4 | 5 | 3 | 3 | 5 | 4 | 5 | 3 |
| food | thirst | | | | | | | | |

| | | | | | | | | |
|---|---|---|---|---|---|---|---|---|
| Overall evaluation | ⊙ | ◯ | ◯ | ◯ | ◯ | ◯ | ◯ | ◯ |
| Total score | 17 | 15 | 15 | 15 | 15 | 17 | 15 | 13 |

| | | Comparative Example | | | |
|---|---|---|---|---|---|
| | | Comparative | Comparative | Comparative | Comparative |
| | | Example 1 | Example 2 | Example 3 | Example 4 |
| (A) Lipids [mass %] | | 6.1% | 2.8% | 5.9% | 3.4% |
| (B) Tannin [mass %] | | 11.8% | 14.5% | 11.6% | 14.8% |
| (C) Hydrophilic | | 9.1% | 9.6% | 4.5% | 3.7% |
| low-molecular-weight tea | | | | | |
| polyphenols [mass %] | | | | | |
| (c) Epigallocatechin gallate | | 4.6% | 4.8% | 1.6% | 1.3% |
| (EGCg) [mass %] | | | | | |
| (c)/(C) [%] | | 51% | 50% | 36% | 34% |
| (D) Semi-hydrophilic | | 1.8% | 1.6% | 2.7% | 2.1% |
| low-molecular-weight tea | | | | | |
| polyphenols [mass %] | | | | | |
| (d) Epicatechin gallate (Ecg) | | 0.9% | 0.7% | 1.2% | 0.4% |
| [mass %] | | | | | |
| (d)/(D) [%] | | 50% | 44% | 44% | 19% |
| (E) Caffeine [mass %] | | 2.7% | 0.7% | 4.6% | 2.4% |
| (A)/(B) | | 0.52 | 0.19 | 0.51 | 0.23 |
| (D)/[(C) + (D)] | | 0.16 | 0.14 | 0.37 | 0.36 |
| Drinking | Matching with rice | 4 | 2 | 1 | 1 |
| tea with | ball (salted rice ball | | | | |
| food | with no filling) | | | | |
| | Matching with cake | 4 | 1 | 3 | 3 |
| | (chocolate cake) | | | | |
| Drinking | Sipping over a | 1 | 1 | 4 | 2 |
| tea | prolonged time | | | | |
| without | One gulp to lessen | 2 | 1 | 2 | 2 |
| food | thirst | | | | |

| | | | | |
|---|---|---|---|---|
| Overall evaluation | Δ | X | Δ | Δ |
| Total score | 11 | 5 | 10 | 8 |

<Quantitation of Lipids>

Lipids in the tea leaves prepared in the Examples and Comparative Examples were quantitated using GC following the method reported by Yamada et al. (Journal for the Integrated Study of Dietary Habits 16 (2004) 369-375), and the total of the quantitated values of palmitic acid, oleic acid, linoleic acid, and linolenic acid was regarded as the lipid content.

<Quantitation of Tannin>

Measurement was performed following the tannin analytical method in methods reported by Anan et al. (Tea Research Journal 71 (1990) 43-74) with modification of the pH of the phosphate buffer to 5.5.

<Quantitation of Catechins and Caffeine>

Analytical samples were prepared following the tannin quantitation method, and catechins and caffeine were quantitated using the HPLC method following the method reported by Goto et al. (T. Goto, Y. Yoshida, M. Kiso and H. Nagashima, Journal of Chromatography A 749 (1996) 295-299).

<Quantitation of Theaflavins>

Analytical samples were prepared following the tannin quantitation method, and theaflavins were quantitated following the method of Andrew P. Nelson et al. (Andrew P. Nelson, Rodney J. Green, Karl V. Wood, Mario G. Ferruzzi, Journal of Chromatography A 1132 2006) 32).

<Quantitation of Gallic Acid>

Analytical samples were prepared following the tannin quantitation method, and gallic acid was quantitated using the HPLC method high-performance liquid chromatography (HPLC) under the conditions below:

Column: Xbridge shield RP18 φ3.5×150 mm (Waters Corp.)
Column temperature: 40° C.
Mobile phase: Phase A: water
: Phase B: Acetonitrile
: Phase C: 1% Phosphoric acid
   Flo rate: 0.5 mL/min
   Injection volume: 5 μL
   Detection: UV detector UV 230 nm (Waters Corp.)

<Quantitation of Theogallin>

Analytical samples were prepared following the tannin quantitation method, and theogallin was quantitated using UPLC under the conditions below:

### Apparatus: ACQUITY

UPLC/PDA system (Nihon Waters K.K.)
Mobile phase (Solution A): 0.1% Phosphoric acid aqueous solution
Mobile phase (Solution B): Acetonitrile
Gradient: Solution B 0% (0 minutes)→0% (1 minute)→3% (3.5 minutes)
Flow rate: 0.5 mL/min

### Detection: UV 275 nm

Sample injection volume: 5 μL
Column temperature: 40° C.

(Preparation of Tea)

Tea was extracted from 10 g each of the tea leaves of Examples 1-8 and Comparative Examples 1-4 by immersing the leaves in 500 mL of 98° C. hot water for 60 seconds. Organoleptic tests were performed using this extracted tea.

(Organoleptic Evaluation)

Six examiners drank and evaluated each tea extracted from the tea leaves of Examples 1-8 and Comparative Examples 1-4 as shown below.

<Matching with Rice Ball>

The examiners drank each tea extracted from the tea leaves of Examples 1-8 and Comparative Examples 1-4 while eating a rice ball (salted rice ball without filling) and evaluated the match based on the criteria below. The temperature of each tea was 80° C.

Matching of Flowery Aroma with Rice Ball Flavor

5 points: Very good
4 points: Good
3 points: Fair
2 points: Slightly bad
1 point: Bad (impairs rice ball flavor)

<Matching with Cake>

The examiners drank each tea extracted from the tea leaves of Examples 1-8 and Comparative Examples 1-4 while eating a cake (chocolate cake) and evaluated the match based on the criteria below. The temperature of each tea was 80° C.

Matching of Bitter Astringent Taste of Tea with the Sweet Taste of Cake

5 points: Very good
4 points: Good
3 points: Fair
2 points: Slightly bad
1 point: Bad (impairs taste of cake)

<Evaluation of Sipping Over a Prolonged Period (Chibidaranomi)>

The examiners drank 200 mL of each tea extracted from the tea leaves of Examples 1-8 and Comparative Examples 1-4 by sipping over 30 minutes, and evaluated the tea based on the criteria below. The temperature of each tea was 40-70° C.

‘Sipping over a prolonged period (chibidaranomi)’ means drinking little by little over a prolonged period to fill hunger between meals or for a change of pace as a tasty beverage (‘Chibidaranomi’ from Neologism Exploration, Hajime Kamei, JapanKnowledge (NetAdvance Inc.) dated Jun. 15, 2002).

Lingering Ascent after Drinking

5 points: Very good
4 points: Good
3 points: Fair
2 points: Slightly bad
1 point: Bad (no remaining aroma, bland)

<One Gulp to Lessen Thirst>

The examiners drank 2 cups of 200 mL of each tea extracted from the tea leaves of Examples 1-8 and Comparative Examples 1-4 with one or two gulps and evaluated the tea based on the criteria below. The temperature of each tea was 15° C.

Refreshing Feeling of after-Taste

5 points: Very good
4 points: Good
3 points: Fair
2 points: Slightly bad
1 point: Bad (irritant taste, such as astringent taste, persistent)

(Results)

The mean scores of the items calculated and rounded are presented in Table 1 shown above.

The values were summed and total scores of 16-20, 12-15, 8-11, and 4-7 were judged as ‘⊙’, ‘◯’, ‘Δ’, and ‘x’, respectively.

The overall evaluations of tea of Examples 1-8 were ‘◯’ or higher and the score of each item was 3 or higher, being favorably evaluated. These teas go well with rice ball and cake as beverage drunk during a meal and are also appropriate for drinking without eating because they have moderate light flowery aroma.

The overall evaluation of tea of Comparative Example 1 was ‘Δ’, being inappropriate for drinking without food. The value of (A)/(B) was high in this tea, and a strong bitter astringent taste and a taste of hard leaves were sensed.

The overall evaluation of tea of Comparative Example 2 was ‘x’, being inappropriate for both drinking with and without food. The values of (A)/(B) and (D)/[(C)+(D)] were high in this tea, and the taste was bland and likely to be sensed as astringent.

The overall evaluation of tea of Comparative Example 3 was ‘Δ’, being inappropriate for drinking with a rice ball and by one gulp. The values of (A)/(B) and (D)/[(C)+(D)] were high in this tea, and the aroma was sensed as strong.

The overall evaluation of tea of Comparative Example 4 was ‘Δ’, being inappropriate for drinking with and without food. The value of (D)/[(C)+(D)] was high in this tea, the aroma was sensed as strong, and the taste was likely to be sensed as astringent.

Based on these findings, it was estimated that tea that goes well with not only sweet tastes but also Japanese-style foods with a light flowery aroma and rich tastiness which can also be drunk without food can be extracted from tea leaves with a value of (A)/(B) of 0.20-0.50 with a value of (D)/[(C)+(D)] of 0.15-0.35.

The after-taste of the tea of Example 8 was slightly bitter. The content of (E) caffeine was higher than in the other Examples.

Based on these finding, it is estimated that bitterness is reduced, tastiness is high, and matching with meals becomes more favorable when tea leaves contain (E) caffeine at 0.5-2.5 mass %.

1. Fermented tea leaves containing (A) lipids, (B) tannin, (C) hydrophilic low-molecular-weight tea polyphenols, and (D) semi-hydrophilic low-molecular-weight tea polyphenols at mass ratios shown in (1) and (2):
(A)/(B)=0.20-0.50 (1)
(D)/[(C)+(D)]=0.15-0.35 (2)

2. Fermented tea leaves described in claim 1 containing (A) lipids at 2-8 mass % of the total mass of tea leaves.

3. Fermented tea leaves described in claim 1 containing (B) tannin at 5-18 mass % of the total mass of tea leaves.

4. Fermented tea leaves described in claim 1 containing (C) hydrophilic low-molecular-weight tea polyphenols at 2-15 mass % of the total mass of tea leaves.

5. Fermented tea leaves described in claim 1 containing (D) semi-hydrophilic low-molecular-weight tea polyphenol at 0.5-5 mass % of the total mass of tea leaves.

6. Furthermore, fermented tea leaves described in claim 1, containing (E) caffeine at 0.5-2.5 mass % of the total mass of tea leaves.

7. Tea bags containing fermented tea leaves described in claim 1.

8. A manufacturing method of fermented tea leaves described in claim 1 characterized by washing raw tea leaves with 60-100° C. water followed by fermentation.

9. A manufacturing method of fermented tea leaves described in claim 8 characterized by fermenting raw tea leaves cleaned by aqueous cleaning by the addition of an enzyme source containing polyphenol-oxidizing enzyme.

10. A manufacturing method of fermented tea leaves described in claim 9 wherein the enzyme source is other raw tea leaves.

11. A manufacturing method of fermented tea leaves described in claim 8 wherein aqueous cleaning is performed by contacting raw tea leaves to water for 10-180 seconds at a mass ratio of raw tea leaves:water=1:5-1:50.

12. A flavor-adjusting method of fermented tea leaves prepared to contain (A) lipids, (B) tannin, (C) hydrophilic low-molecular-weight tea polyphenols, and (D) semi-hydrophilic low-molecular-weight tea polyphenols at the mass ratios presented in (1) and (2) below:
(A)/(B=0.20-0.50 (1)
(D)/[(C)+(D)]=0.15-0.35 (2)
